(19) United States
(12) Patent Application Publication
(10) Pub. No.: US 2005/0180035 A1
(43) Pub. Date: Aug. 18, 2005

(54) Rotation particle display apparatus and method for manufacturing rotation particle display apparatus

(75) Inventors: Naoyuki Hayashi, Kawasaki (JP); Shino Tokuyo, Kawasaki (JP); Tsuneo Watanuki, Kawasaki (JP); Norio Sawatari, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/073,861

(22) Filed: Mar. 8, 2005

Related U.S. Application Data
(63) Continuation of application No. PCT/JP03/02151, filed on Feb. 26, 2003.

(51) Int. Cl. G02B 5/08; G02B 7/182

(52) U.S. Cl. 359/883

(57) ABSTRACT

A rotation particle display apparatus is disclosed that includes plural rotation particles for rotating in accordance with an applied electric field for displaying an image, each rotation particle having a first region and a second region. The first and second regions have different colors and different charge characteristics. When the rotation particles are viewed two-dimensionally from a direction where the borderline between the first and second regions is situated substantially at the center of the rotation particle and where the first region has an area which is substantially the same as that of the second region, the proportion of the rotation particles that satisfy a relation of 1.0≦L/R≦1.2 is 80% or more, where “L” represents the length of the borderline between the first and second regions, and “R” represents the diameter of a circle corresponding to a contour of the rotation particle.

### CROSS-REFERENCE TO RELATED APPLICATIONS

This application is a U.S. continuation application filed under 35 USC 111(a) claiming benefit under 35 USC 120 and 365(c) of PCT application JP 2003/02151, filed Feb. 26, 2003. The foregoing application is hereby incorporated herein by reference.

### BACKGROUND OF THE INVENTION

1. Field of the Invention

The present invention relates to a rotation particle display apparatus and a method for manufacturing the rotation particle display apparatus, and more particularly to a rotation particle display apparatus and a method for manufacturing the rotation particle display apparatus for providing rotating particles of two colors that provide satisfactory stability and controllability during a rotation operation.

2. Description of the Related Art

In recent years and continuing, a sheet type display apparatus which is flexible and requires no power source is provided. Since the sheet type display apparatus can be handled in a manner similar to a sheet of paper, it is referred to as, for example, electronic paper, a paper-like display, or digital paper. As for examples of a display element in the sheet type display apparatus for displaying images by changing optical absorption or optical reflection with an electric field, there are (1) a microcapsule encapsulating a solvent having electrophoretic particles and a coloring agent dispersed therein, (2) a liquid crystal/polymer complex film containing dichromatic pigment and a smectic liquid crystal, and (3) a microcapsule encapsulating an insulating liquid along with a rotation particle having two hemispheres that are of different colors and electrical characteristics.

Since the sheet type display apparatus is nonvolatile, requires no saving operation, and has the display element was kept between two polymer films, for example Polyethyleneterephtalate (PET), were formed electrodes, a thin, lightweight, and flexible sheet type display apparatus can be obtained.

More particularly, the sheet type display apparatus is able to display information by rotating color-coded rotation particles by using an electric field and manipulating the optical contrast of the color-coded rotation particles. In obtaining a satisfactory optical contrast, satisfactory operational stability and controllability of the rotation particles are desired.

U.S. Pat. Nos. 4,126,854 and 4,143,103 disclose a display apparatus employing a microcapsule encapsulating an insulating liquid along with a rotating particle having two hemispheres that are of different colors and electrical characteristics. The display apparatus is provided with an optically transparent substrate having plural cavities filled with a dielectric liquid, in which each cavity has one rotation particle installed therein.

Since each rotation particle has two areas having different colors and electrical characteristics, directions of rotation particles become inverted when an electric field is applied for causing electrophoresis and rotational movement.

As for methods in manufacturing rotation particles, there are, for example, (1) a method of combining two types of molten wax particles of different colors, sphering the combination using surface tension, and solidifying the spheres (See U.S. Pat. No. 5,262,098), (2) a method of vapor-depositing or coating the surfaces of particles (e.g. glass particles, resin particles) with, for example, metal, carbon black, or antimony sulfide (See Japanese Laid-Open Patent Application Nos. 11-85067 and 11-85068), or (3) a method of color-developing particles of a photosensitive material by applying an exposure process, a development process, and a fixing process of a photographic or electrophotographic method.

Another method of manufacturing rotation particles by using colored resin is shown in Japanese Laid-Open Patent Application No. 1-282589, in which rotation particles are formed by fabricating a rolled sheet manufactured by adhering together resin plates of two colors with a roller or a pressing machine, grinding the resin sheet with a turbo type grinding machine, heating the ground resin particles with hot air, and classifying the heated resin particles. However, this method causes unevenness in size and shape of the ground resin particles since a turbo type grinding machine is used in the grinding process. In addition, although rotation particles of a desired particle diameter can be obtained by the classification process, the rotation particles would have poor yield. Furthermore, the shape of the end faces during the grinding process has an effect on the volume ratio of the different color resins and the border between the different colors. Therefore, this method which uses the turbo type grinding machine creates block pieces with uneven end faces. This leads to an uneven volume ratio and a meandering boundary between the two colors. As a result, rotational movement of the rotation particles becomes uneven and satisfactory contrast cannot be attained for the desired display image.

Another method of manufacturing rotation particles is shown in Japanese Laid-Open Patent Application No. 2002-122893, in which rotation particles are formed by adhering together resin plates of two different colors, sandwiching the resin plates with a substrate, for example, PET film, and cutting the resin plates into evenly sized resin pieces with a rotary blade, and sphering the resin pieces by a melting and heating process. This method enables easier fabrication of rotation particles with even diameter since the resin pieces are evenly sized. Nevertheless, there is a possibility that molten resin pieces would fuse together during the heating process for sphering the resin pieces, thereby causing uneven particle diameters. As a result, rotational movement of the rotation particles becomes uneven and satisfactory contrast cannot be attained for the desired display image.

Furthermore, Japanese Registered Patent No. 2860790 discloses a technology of forming rotation particles by using a wax-like material having low specific gravity, in which the sphericity of the rotation particles, the relation between the diameters of the rotation particles and that of the cavities housing the rotation particles, and the area ratio of the different colors, etc., are defined for the rotation particle. This technology states that a satisfactory responsiveness and movement performance of the rotation particle can be attained. However, Japanese Registered Patent No. 2860790 does not specifically describe, for example, how the sphericity of the rotation particle is controlled nor how the area ratio of the different colors are controlled.

### SUMMARY OF THE INVENTION

Accordingly, it is an object of the present invention to provide a rotation particle display apparatus that obviate the above-described problems.

A more specific object of the present invention is to provide a rotation particle display apparatus including: a plurality of rotation particles for rotating in accordance with an applied electric field for displaying an image, each rotation particle having a first region and a second region, the first and second regions having different colors and different charge characteristics; wherein when the rotation particles are viewed two-dimensionally from a direction where a borderline between the first and second regions is situated substantially at a center of the rotation particle and where the first region has an area which is substantially the same as that of the second region, the proportion of the rotation particles that satisfy a relation of 1.0≦L/R≦1.2 is 80% or more, wherein “L” represents a length of the borderline between the first and second regions, and “R” represents a diameter of a circle corresponding to a contour of the rotation particle.

Accordingly, for example, in a case of L/R=1, the borderline between the first and second regions is a straight line passing through the center of the circle. The borderline becomes more wave-like or jagged as the value of L/R increases. Since the first and second regions of the rotation particle have different charge characteristics, a rotation moment is generated from Coulomb force when an electric field is applied to the rotation particle; thereby the rotation particle is rotated approximately 180 degrees. Therefore, as the borderline becomes more wave-like, the rotation moment loses balance; thereby causing deviation from the rotation stop position and unstable rotational movement. Accordingly, a satisfactory rotational movement and a sufficient contrast can be attained for the rotation particle display apparatus when the proportion of the rotation particles that satisfy a relation of 1.0≦L/R≦1.2 is 80% or more.

According to another aspect of the present invention, the rotation particle display apparatus may further include first and second electrodes for applying the electric field to the rotation particles; a transparent substrate situated between the first and second electrodes; a plurality of cavities formed in the transparent substrate; and a dielectric liquid filling the cavities.

Accordingly, by obtaining rotation particles where the proportion of the rotation particles that satisfy a relation of 1.0≦L/R≦1.2 is 80% or more, a satisfactory stable rotational movement and a sufficient contrast can be attained for the rotation particle display apparatus.

According to another aspect of the present invention, a method of manufacturing a rotation particle display apparatus includes the steps of: a) forming two resin plates of two different colors from two resin materials; b) forming a two color layered resin substrate by adhering the two resin plates; c) cutting the two color layered resin substrate into resin pieces; d) forming the resin pieces into spherical rotation particles by heating the resin pieces inside a liquid; and e) classifying the rotation particles according to the particle diameters of the rotation particles.

Accordingly, since the resin pieces are sphered (i.e. formed into spherical shapes) by heating the resin pieces inside the liquid, a monotonous borderline between the two different color regions of the rotation particle can be obtained. Furthermore, the distribution of the particle diameter of the rotation particles can be narrowed by classifying the rotation particles according to their particle diameters. Thereby, rotation particles having satisfactory rotational movement and stable rotation stop positions can be provided.

According to another aspect of the present invention, a melt viscosity ratio between the two resin materials forming the first and second regions of the rotation particle ranges from 0.5 to 2.0 at a temperature of 190° C. By controlling the melt viscosity ratio, the balance between the two resin materials can be maintained during the heating of the resin pieces in the sphering process (forming the resin pieces into spherical shape resin particles). Accordingly, a more monotonous borderline can be obtained for the rotation particle.

### BRIEF DESCRIPTION OF THE DRAWINGS

FIGS. 1A and 1B are drawings for describing a principle of the present invention;

FIG. 2 is a drawing showing a rotation particle viewed from an arrow X direction in the middle row of FIG. 1B;

FIG. 3 is a cross-sectional drawing showing a rotation particle display apparatus according to an embodiment of the present invention;

FIG. 4 is a flowchart showing a process for manufacturing a rotation particle display apparatus according to an embodiment of the present invention;

FIG. 5A is a drawing showing an example of a still image of a rotation particle;

FIG. 5B is a drawing showing an edge enhanced image of the still image of FIG. 5A; and

FIG. 6 is a table showing results of evaluating L/R values and contrasts of the rotation particle display apparatuses of the first-third examples of the present invention and the first-second comparative examples.

### DESCRIPTION OF THE PREFERRED EMBODIMENTS

Embodiments of the present invention are described in detail below.

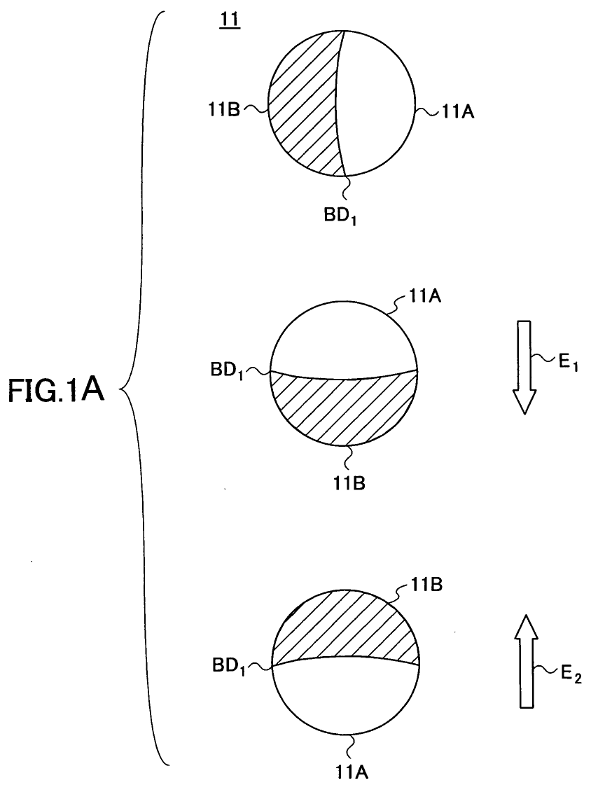

First, a principle of the present invention is described with reference to FIGS. 1A and 1B. Two dimensional images of rotation particles 11 and 12 are shown in FIGS. 1A and 1B. An electric field is applied from an upper side to a lower side (or from the lower side to the upper side) of each of the rotation particles 11, 12. The rotation particles 11, 12 are observed from a position which is perpendicular to the electric field. As shown in the top rows of FIGS. 1A and 1B, the rotation particles 11, 12 have two regions 11A, 11B, 12A, 12B which are colored black and white. Each region 11A, 11B, 12A, 12B covers substantially half of the surface area of the corresponding rotation particle 11, 12. In a case where the rotation particles 11, 12 have not yet been applied with the electric field, the rotation particles 11, 12 face toward a given direction. It is to be noted that the peripheral spaces surrounding the rotation particles 11, 12 are filled with a dielectric liquid (not shown).

Next, when the rotation particle 11 illustrated in the top row of FIG. 1A is applied with an electric field from an arrow direction E₁ (−Z direction) shown in the middle row of FIG. 1A, a Coulomb force works in an upward direction with respect to a negative charged white region 11A of the surface of the rotation particle 11 and in a downward direction with respect to a positive charged black region 11B. The rotation moment of the Coulomb force causes rotational movement of the rotation particle 11. According to the rotational movement, the white region 11A is positioned in the upper side and the black region 11B is positioned in the lower side. The rotation of the rotation particle 11 stops at a position where energy is equilibration. In a case where a borderline BD₁ between the white region 11A and the black region 11B is a monotonous line, the rotation particle 11 stops rotation at a position where a hemisphere of the white region 11A is situated at the upper side and a hemisphere of the black region 11B is situated at the lower side, as shown in the middle row of FIG. 1A. Therefore, when the rotation particle 11 is viewed from a top side of FIG. 1A (side of which the display apparatus is viewed), the rotation particle 11 is seen as a white circle.

Next, when the rotation particle 11 illustrated in the middle row of FIG. 1A is applied with an inverted electric field from an arrow direction E₂ (Z direction) shown in the bottom row of FIG. 1A, the rotation particle 11 rotates around a rotational axis that is perpendicular to the Z direction. Thereby, the negative charged white region 11A is positioned in the lower side and the positive charged black region 11B is positioned in the upper side. When the rotation particle 11 is viewed from the top side of FIG. 1A, the rotation particle 11 is seen as a black circle.

Meanwhile, in a case where a borderline BD2 between a white region 12A and a black region 12B of the surface of the rotation particle 12 is diverse, when the rotation particle 12 illustrated in the top row of FIG. 1B is applied with an electric field from an arrow direction E₁ (−Z direction) shown in the middle row of FIG. 1B, the rotation particle 12 rotates in a similar manner as the rotation particle 11, in which the white region 12A is positioned in the upper side and the black region 12B is positioned in the lower side. However, in this case, the stop position of the rotation particle 12 deviates from its expected stop position and the borderline of the rotation particle becomes an irregular borderline of BD₂ rather than a regular borderline of BD_{2′}.

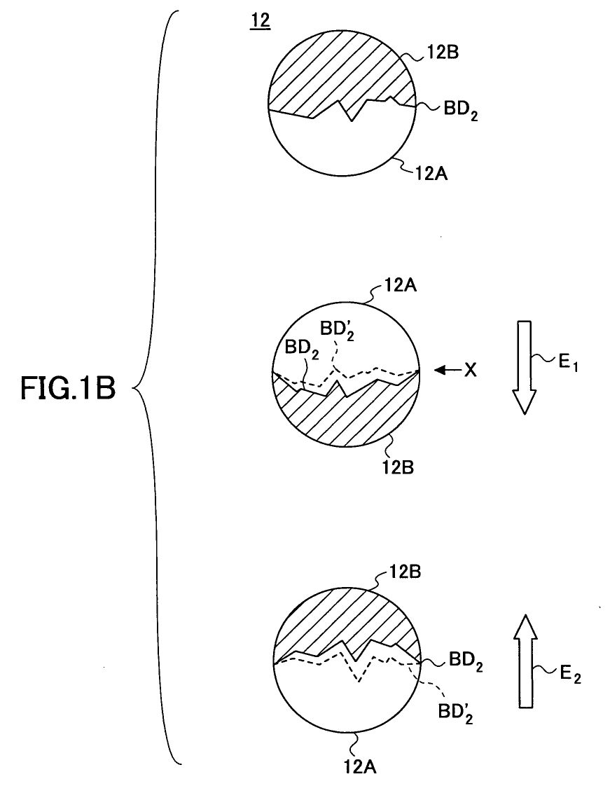

FIG. 2 is a drawing showing the rotation particle 12 when viewed from a direction of arrow X shown in the middle row of FIG. 1B. When the rotation particle 12 is viewed from the top side of FIG. 2, the rotation particle 12 is seen as a white circle with a black colored part. This causes noise of the displayed image.

Next, when the rotation particle 12 illustrated in the middle row of FIG. 1B is applied with an inverted electric field from the arrow direction E₂ (Z direction) shown in the bottom row of FIG. 1B, the stop position of the rotation particle 12 deviates from its expected stop position.

The position of the stop position of the rotation of the rotation particle 12 is observed as follows.

The rotation moment of the rotation particle 12 depends on the distribution of the charge on the surface of the rotation particle 12, and more particularly, on the distribution of the charge at the proximity of the borderline BD₂ (being substantially perpendicular to the direction of the Coulomb force) on the surface of the rotation particle 12. In other words, it is observed that the direction and size of the rotation moment are determined by the form of the borderline BD₂. In the case where the borderline BD₁ of the rotation particle 11 is monotonous, the Coulomb force for both upward and downward directions can be uniformly generated. Accordingly, a balanced rotation moment is obtained in a state where the hemisphere of the white region 11A can be situated at the upper side and the hemisphere of the black region 11B can be situated at the lower side. However, in the case where the borderline BD₂ is diverse, the Coulomb force for both upward and downward directions would be uneven. Accordingly, a balanced rotation moment is obtained in a state where one of the hemispheres of the white region 12A or black region 12B is tilted toward the other hemisphere.

Based on the above-described observation and the below-described experiments, the inventors have arrived at the present invention.

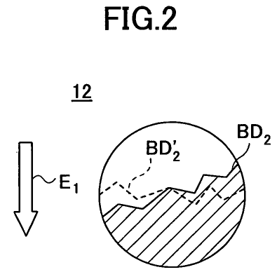

FIG. 3 is a schematic cross-sectional drawing showing a rotation particle display apparatus 20 according to an embodiment of the present invention. With reference to FIG. 3, the particle rotation display apparatus 20 includes a lower electrode 22 and an upper electrode 23 which are formed on a transparent resin film 21, a transparent substrate 24 disposed between the lower electrode 22 and the upper electrode 23, cavities 25 formed in the transparent substrate 24 and filled with a dielectric liquid 26, and rotation particles 28 which are rotatable inside the dielectric liquid 26 filling the cavities 25.

The rotation particle 28 includes areas 28A and 28B which are color-coded in a substantially hemispherical manner. These areas 28A and 28B are colored with coloring agents such as a pigment or a dye, and have different electrification characteristics (charge) in accordance with difference in zeta levels of the coloring agents and a binder. When an electric field is applied to the rotation particles via the transparent substrate 24 and the dielectric liquid 26 by applying voltage to the upper and lower electrodes 22, 24, the rotation particles rotate in correspondence with the direction of the electric field. Accordingly a viewer 30 can view a desired display image.

The rotation particles 28 are set with a particle diameter value averaging from 2 μm to 500 μm (average particle diameter), and more preferably in a range from 10 μm to 100 μm. If the particle diameter is greater than 500 μm, the voltage applied for the rotation would be too large and costly. Furthermore, the display image could not be displayed with high precision. Furthermore, by setting the particle diameter to a value of 100 μm or less, the thickness of the transparent substrate 24 can be reduced and the voltage applied for rotating the rotation particles 28 can be reduced. On the other hand, setting the particle diameter to a value less than 10 μm causes difficulty in controlling the particle diameter distribution of the rotation particles 28.

The coefficient of variation with respect to the particle diameter distribution of the rotation particles 28 may be expressed as: standard deviation/average particle diameter×100(%). The coefficient variation is set to 20% or less (preferably 15% or less). When the coefficient variation exceeds 20%, the rotation particles 28 may deviate from their desired stop positions and adversely affect contrast. That is, in a case where the applied electric field is constant, the rotation particles 28 having small diameter tend to deviate from their stop position. In order to reduce the coefficient of variation, it is effective to improve cutting precision and execute a classification process during formation of resin pieces (described below).

It is to be noted that measurement of the distribution of particle diameter of the rotation particles 28 is executed with a Coulter method in which a Multisizer IIE manufactured by Beckman Coulter Inc. is used. The volume average particle diameter and the coefficient of variation is measured under the below given conditions.
aperture diameter: 200 μm
sample number: 10000

As described above, the inventors of the present invention found that deviation in the stop position and irregular rotation movement of the rotation particles 28 are caused when the border between the two color hemispheres of the rotation particle becomes uneven. Thus, under a condition where a rotation particle having a first region and a second region of different colors is viewed from a direction in which the first and second regions have a substantially same area and have a borderline situated substantially at a center therebetween, the inventors found that there is a close relation between the value of the ratio of the length of the borderline L to the particle diameter of the rotation particle R (i.e. L/R value) and the rotational movement as well as rotation stop position. In a case where the L/R value is 1.0, the borderline is a straight line and both the rotational movement and the rotation stop position are normal. In a case where the L/R value is 1.0<L/R≦1.2, the borderline becomes a moderate wave-like line. Furthermore, in the case where the L/R value is 1.0<L/R≦1.2, although the rotation particle is able to rotate in accordance with the electric field, the rotation stop position is slightly tilted. In a case where the L/R value is 1.2≦L/R<1.4, the borderline is formed having excessively protruding portions. Furthermore, in the case where the L/R value is 1.2<L/R≦1.4, although the rotation particle is able to rotate in accordance with the electric field, the rotation stop position is in a state where the borderline is situated toward the viewer side. In this state, the rotation particle may be viewed not only as the desired color, but also as another color. In a case where the L/R value exceeds 1.4, the protruding portions in the borderline become larger, and a spot(s) having a color of one of the two regions may be seen in a portion the other region. Furthermore, in the case where the L/R value exceeds 1.4, the rotation particle is unable to rotate in accordance with the electric field. This causes irregular rotational movement in which, for example, rotational axes penetrating through respective areas are created, and contrasting colors (e.g. black and white) are prevented from being displayed.

The contrast of a display apparatus, that is, reflectance ratio of, in a case of displaying one color and a case of displaying the other color, changes in accordance with the L/R value of each of the rotation particles. The inventors of the present invention found that a sufficient visibility can be attained for the display apparatus in a case where 80% or more of all of the rotation particles have an L/R value in the range 1.0≦L/R≦1.2. That is, in a case where the proportion of the particles having an L/R value greater than 1.2 is less than 20%, visibility can be obtained even though particles having another color mixed with a desired color (noise) may be found in a small proportion. It is more preferable when the proportion of rotation particles having an L/R value in the range 1.0≦L/R≦1.2 is larger, for example 90% or more, so that a more satisfactory contrast can be obtained.

Next, embodiments of the configurations of the rotation particle and the rotation particle display apparatus, and the method of manufacturing the rotation particle display apparatus according to the present invention are described in further detail below.

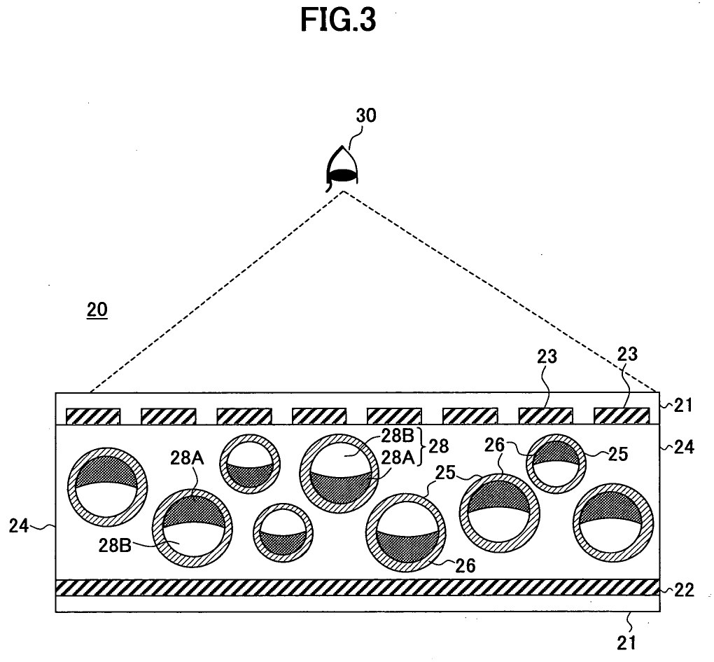

First, the configuration of the rotation particle and the method of manufacturing the rotation particle display apparatus according to an embodiment of the present invention are described with reference to FIG. 4. FIG. 4 shows a flowchart of a process of manufacturing the rotation particle display apparatus according to an embodiment of the present invention.

First, resin materials of two different colors are fabricated (Step S102). The resin material is formed, for example, by heating and kneading a binder and a coloring agent with use of a roller mill and/or an extruder. The binder may be, for example, a known thermoplastic resin such as polyethylene, polypropylene, polystyrene, acryl, or nylon. The use of polyethylene or polypropylene as the binder is preferable from an aspect of attaining cutting performance during a subsequent process of cutting the resin material into resin pieces. The coloring agent may be, for example, a known pigment such as a white pigment (e.g. titanium oxide, silicon dioxide, barium titanate, calcium carbonate, and alumina), a black pigment (e.g. carbon black, magnetite), phthalocyanine pigment, an azo pigment, a quinacridone pigment, a perylene pigment, or a perynone pigment; or a known dye such as an acid dye, a basic dye, a reactive dye, direct dye, or a dispersing dye.

Although the white pigment of titanium dioxide may be either an anatase type or a rutile type, the rutil type having a high hiding characteristic is preferable from the aspects of whiteness and optical reflectivity. The titanium oxide may be surface treated with an inorganic substance such as hydrated aluminum oxide, hydrated silicon oxide, or with an organic substance such as polyhydric alcohol, multivalent amine, metallic soap, alkyl titanate or polysiloxane. Thus, the titanium oxide can have an enhanced dispersibility in the binder and a higher degree of whiteness. Furthermore, it is even more preferable to add a fluorescent brightening agent.

Although no charge control agent is added in this embodiment of the present invention, the adding of the above-described coloring agents changes both charging property and charge amount. However, it is possible to add charge control agents of negative or positive charge, for example, carixarene, nigrosine dye, quaternary ammonium salt, a polymer having amino group, a azo dye having metal, a salicylic acid complex compound, a phenol compound, azo chromes, or azo zincs.

At a temperature from the softening point of the two resin materials to 220° C., the ratio of the melt viscosity of the two resin materials is set to 0.5-2.0. By setting the ratio of the melt viscosity to 0.5-2.0, the borderline in the rotation particle fabricated from the two resin materials of different colors, that is, the borderline between the two different colored areas of the rotation particle can be formed as a monotonous (unvarying) line during a subsequent sphering process (described below). When the ratio of the melt viscosity is less than 0.5 or greater than 2, a diverse (varying) borderline is formed in which, for example, the side of one resin material having less melt viscosity irregularly covers part of the side of the other resin material. It is to be noted that the temperature of the melt viscosity is related to the temperature of the heating process in the subsequent sphering process. Since the temperature of the heating process ranges from 100° C. to 220° C. according to an embodiment of the present invention, the ratio of the melt viscosity is sufficient under a temperature of 190° C. In a case where the softening point of one of the resin materials is higher than 190° C., the ratio of the melt viscosity is set to a temperature that is no less than the melting point.

More specifically, the ratio of the melt viscosity may be increased or decreased by, for example, adjusting the proportion of the coloring agents. It is to be noted that melt viscosity according to an embodiment of the present invention is measured with a viscoelasticity measurement apparatus (manufactured by Rheometric Scientific Inc., Name of Product: ARES). Complex viscosity is measured under the conditions below, in which a real part of the measurement is the melt viscosity.
Plate: parallel plate (diameter 25 mm)
Measurement mode: Dynamic mode
Measurement frequency: 1 Hz

Furthermore, the softening points of the resin materials are measured in accordance with a JIS K7207, in which a vicat softening point is employed.

Next, each of the resin materials are molded into a single layer resin plane by employing, for example, a cast molding method or a rolling method (Step S104). For example, a cast film molding apparatus (e.g. manufactured by SHI Modern Machinery Ltd.) may be used for the cast molding method. The cast film molding apparatus includes, for example, an extruder for heating and pressuring the resin material, a T-die for molding the resin material into a thin plane with a predetermined thickness, and a cast roller for cooling the resin plane obtained from the T-die. According to an embodiment of the present invention, the resin material is provided to the extruder. The resin material is heated to a temperature of 150° C. The extruder is set with an extruding rate of approximately 30 kg/hour. Then, the resin material is supplied to the T-die. The T-die is provided with an opening having a width of 0.5 mm, for example. The cast roller having a roller diameter of 300 mm is set with a roller speed of 8 m/minute under a temperature of 20° C. The cast roller cools and stabilizes the resin material that is fabricated into a sheet-like form. The sheet-like resin material is formed with a thickness of approximately 20 μm. It is to be noted that the thickness of the resin material can be controlled by adjusting the roller gap of the cast roller. By employing the T-die, the resin material can be fabricated into a sheet-like form with a uniform thickness. By employing the cast roller, the resin material can be precisely fabricated with a desired thickness and thus with a more uniform thickness. Accordingly, unevenness or diversity can be prevented from being formed in the borderline between the two areas. It is to be noted that the thickness of the resin plates is suitably set in correspondence with the size of the resin pieces obtained in a subsequent process (described below).

Furthermore, the resin plates may be formed by a rolling method, in which the resin materials are sandwiched between two sheets of film and rolling the film having the resin materials sandwiched therebetween. More specifically, resin materials having a substantially planar form are sandwiched between two sheets of PET film (thickness: 10 μm) and delivered through rolling rollers. The rolling rollers are disposed in two levels with gaps of 100 μm and 40 μm and apply a temperature of 150° C. to the resin materials. Then, the resin materials are cooled by cooling rollers, thereby being fabricated into resin plates, each of which having a thickness of approximately 20 μm.

Next, the resin plates of two different colors are welded and adhered to each other, to thereby form a two color layered resin substrate. More specifically, the resin plates of each color are adhered, sandwiched between heat resisting film such as Kapton (registered trademark) film, and thermally pressed by, for example, a roller or a press. According to the embodiment of the present invention, the temperature of the thermal pressure ranges from 100° C. to 150° C., the thermal pressure ranges from 9.8×10⁵ Pa to 4.9×10⁶ Pa, and the pressing time ranges from 1 minute to 10 minutes.

Alternatively, the two color resin substrate may be fabricated by employing a method of dissolving and coating the resin materials or employing a method of dipping the resin materials, in which one resin coating material is layered onto the other resin coating material after the other resin coating material is formed. More specifically, the two different color resin materials are dissolved in an organic solvent to form respective resin coating materials. Then, one of the two resin coating materials is fabricated as a first resin layer with a thickness of approximately 20 μm by employing, for example, a spin coater, a doctor blade, a bar coater, or a dip coater and drying the resin coating material. Then, a second resin layer with a thickness of approximately 20 μm is fabricated by coating and drying the other one of the two resin coating materials onto the first resin layer. The resin material may be a known material that dissolves in an organic solvent, such as acryl or polystyrene. The organic solvent may be, for example, alcohol, ketone, hydrocarbon, or a hydrocarbon halide.

Next, the two color layered resin substrate is cut into resin pieces in sizes ranging from several tens of microns to several hundred microns by using, for example, a metal blade, a wire, or a laser (Step S108). More specifically, the two color layered resin substrate is adhered to an adhesive film. Then, the adhesive film is fixed to a process stage of a cutter. In this state, the two color layered resin substrate is cut by the cutter such as a laser cutter or a rotary blade. Accordingly, resin pieces can be prevented from moving or separating after being subjected to the cutting process, thereby enabling resin pieces to be cut into desired sizes without being displaced from other cut resin pieces. It is to be noted that a rotary blade made of steel or ceramic is preferable as the rotary blade for alleviating unevenness of the cut face of the resin pieces and attaining a straight or a moderate wave-like borderline of the rotation particle that is to be formed in a subsequent process. Furthermore, a CO2 laser or a YAG laser (including higher harmonic wave), for example, can be employed as the laser cutter.

Next, the resin pieces are separated from the adhesive film and are recovered. More specifically, the resin pieces are released from the adhesive film by dissolving the substrate of the adhesive film or the adhesive agent of the substrate of the adhesive film. Here, the solvent used in dissolving the substrate or the adhesive agent is a solvent that does not dissolve the two color layered resin substrate. For example, in a case where the adhesive agent is poly vinyl alcohol, polystyrene, or polyester, water or alcohol may be employed as the solvent. By employing such solvent, the resin pieces can be prevented from deforming and can be released from the adhesive film without being applied with mechanical stress. Furthermore, in recovering the resin pieces, silicone oil, for example, may be employed as a releasing agent. By employing such releasing agent, deformation of the resin pieces can be prevented more sufficiently. It is preferable for the silicone oil to be of a same kind as the silicone oil employed in a subsequent sphering process (described below).

Furthermore, a metal plate may be employed as an alternative of the adhesive film. In this case, the two color layered resin substrate and the metal plate (e.g. stainless steel, aluminum) are adhered to each other by being overlapped and heated. After the above-described cutting process, the resin pieces are released from the metal plate by cooling with a refrigerant. More specifically, when the cooling is executed, the difference in the coefficients of thermal expansion between the resin pieces and the metal plate causes shrinkage of the metal plate and hardening of the resin pieces; thereby the resin pieces are released from the metal plate. Ethanol, isopropyl alcohol, chlorofluorocarbon, or liquid nitrogen, for example, may be employed as the refrigerant.

Next, after the resin pieces are dried, a sphering process (forming resin pieces into spherical shapes) is performed on the resin pieces (Step S110). The sphering process is conducted by dispersing the resin pieces in a container (e.g. stainless beaker) containing a heating medium, melting/softening the resin pieces with heat, to thereby achieve self-sphering of the resin particles. As for the heating medium, silicone oil, for example, may be employed. By heating the resin pieces via the silicone oil, the surface of the resin pieces can be uniformly heated. Accordingly, the rotation particles can be formed with a higher sphericity. In addition, the silicone oil is able to prevent a releasing effect or aggregation among the resin pieces. As for the silicone oil, dimethyl silicone oil, phenyl methyl silicone oil, or various denatured silicone oil, for example, may be employed. From the aspects of attaining a higher sphericity and preventing aggregation of the resin pieces, it is preferable for the kinematic viscosity of the silicone oil, for example, to range from 3×10⁻⁴ m²/s to 1×10⁻² m²/s (300 cSt to 10000 cSt) at a temperature of 25° C., and more preferably to range from 3×10⁻⁴ m²/s to 1×10⁻³ m²/s (300 cSt to 1000 cSt) in a temperature of 25° C. The resin pieces become subject to sedimentation and aggregation when the kinematic viscosity is less than 3×10⁻⁴ m²/s. The time for recovering the resin pieces becomes extensive when the kinematic viscosity is more than 1×10⁻² m²/s.

Furthermore, the difference between the specific gravity of the silicone oil and that of the resin pieces is no more than 0.3 in a temperature of 25° C. When the difference is greater than 0.3, the resin pieces become subject to floating, sedimentation, and/or aggregation in the silicone oil.

During the heating of the resin pieces inside the heating medium, the resin pieces may be, for example, shaken with a shaker or agitated with an ultrasonic homogenizer. This prevents resin pieces from aggregating or adhering to the inner wall of the container. In addition, the distribution of the particle diameters of the rotation particles can be narrowed, thereby improving the yield in a subsequent classification process.

The heating temperature in the sphering process is set to a temperature that is higher than the softening point of the resin pieces, for example, 100° C.-220° C. (more preferably, 100° C.-200° C.). The time of the sphering process is set to 10 seconds-120 seconds.

Then, in order to allow the rotation particles to maintain their spherical shapes obtained in the sphering process, the rotation particles are mixed with a silicone oil at 25° C.-100° C. and cooled to a temperature that is no more than the softening point of the resin material of the rotation particles. By cooling the rotation particles to a temperature no more than the softening point, fusing among the rotation particles can be prevented, unevenness in the shapes and particle diameters of the rotation particles can be controlled, and yield of the rotation particles can be enhanced. It is preferable for the silicone oil used for cooling the rotation particles to be the same kind as the silicone oil used for the above-described heating process. This prevents the silicone oil, being used for both heating and cooling, from separating from each other.

Next, the rotation particles are classified and recovered by employing a strainer (Step S112). The classification process is performed in several steps by using a mesh having a mesh size (mesh diameter) of 10 μm-200 μm. This classification process is effective for narrowing the particle diameter distribution of the rotation particles. However, the yield of the rotation particles will decrease in correspondence with the increase in the number of passes made in the classification process. The yield is closely related to factors such as the performance of the cutting process and/or the sphering process. Then, the classified rotation particles are washed with a washing apparatus, for example, SH200-0.65 cst (Toray Dow Corning Silicone Co. Ltd.) and dried with, for example, a vacuum dryer.

Next, the rotation particles are dispersed/filled in a transparent substrate (Step S114). First, an uncured silicone elastomer, for example, a two component curing type silicone rubber KE 106 (Toray Dow Corning Silicone Co. Ltd.) is agitated/dispersed with the rotation particles so that the silicone elastomer may be of 50%-55% volume. Then, the silicone elastomer is coated onto a Teflon (trademark) coated film with a blade method, for example, thereby obtaining a coating with a thickness of several hundred μm. Then, the coating is heated and cured. Hence, a cured silicone elastomer having rotation particles dispersed therein (i.e. transparent substrate) is fabricated.

Next, the transparent substrate is swelled with a dielectric liquid such as silicone oil and the peripheries of the rotation particles of the transparent substrate are filled with the dielectric liquid (Step S116). More particularly, the transparent substrate and the silicone oil are hermetically sealed in, for example, a vinyl bag. Here, the volume ratio between the transparent substrate and the silicone oil is, for example, 1:2. Then, the vinyl bag is placed in an ultrasonic cleaner filled with water and is subjected to ultrasonic waves for several minutes. Then, the transparent substrate is extracted and is dried at room temperature. After the transparent substrate is dried, the transparent substrate is dipped in silicone oil for several hours to several tens of hours.

It is to be noted that a method using interfacial polymerization as shown in Japanese Laid-Open Patent Application No. 8-234686 may be alternatively used as the method for filling the cavities with the rotation particles and the dielectric liquid. In Japanese Laid-Open Patent Application No. 8-234686, a dielectric liquid and rotation particles are coated by resin film to form microcapsules, and then the microcapsules are dispersed in a transparent substrate.

Next, a PET film having ITO electrodes disposed in a stripe-like manner is adhered to both sides of the silicone elastomer, so that the ITO electrodes may be disposed in a perpendicularly intersecting manner (Step S118). Then, a feeder circuit is provided for selectively applying voltage to the ITO electrodes. Thereby, the fabrication of the rotation particle display apparatus is completed.

With the embodiment of the present invention, the two color regions of the rotation particles have an even pressure applied during the heating in the sphering process since the melt viscosity of the resin material is set in a range from 0.5 to 2.0. Thereby, the region of one of the resin materials is prevented from being covered by the region of the other one of the resin materials. Accordingly, the borderline between the two color areas can be formed as a straight line or as a moderate wave-like form. As a result, rotation particles yielding satisfactory control of rotational movement and sufficient movement stability can be obtained, and thus a rotation particle display apparatus including the rotation particles can provide high contrast particles.

Furthermore, by setting the kinematic viscosity of the silicone oil to the above-described range, the sphericity of the rotation particles can be improved, aggregation/fusion among the molten resin particles can be prevented, and the distribution of the particle diameters of the rotation particles can be narrowed. Furthermore, by executing the classification process, excessively large rotation particles can be removed, and the distribution of the particle diameters of the rotation particles can be further narrowed.

### FIRST EXAMPLE

According to a first example of the present invention, a white color resin is fabricated by kneading 80 parts by weight of a low density polyethylene of Petrothene 353 (manufactured by Tosoh Corporation, melt index: 150) and 20 parts by weight of a hydrophobic titanium dioxide (anatase type, particle diameter: 120 nm) by using a roller mill at a heating temperature of 105° C.

A black color resin is fabricated by kneading 82 parts by weight of Petrothene 353 (manufactured by Tosoh Corporation), 2 parts by weight of carbon black, and 16 parts by weight of magnetite by using a roller mill in a heating temperature 105° C. Here, the ratio of the melt viscosity of the color resins (melt viscosity of the white color resin/melt viscosity of the black color resin) at a temperature of 190° C. is 1.28.

Next, the white color resin is applied to an extruder of a cast film molding apparatus (e.g. manufactured by SHI Modern Machinery Ltd.). By setting the heating temperature to 150° C. and the extrusion rate to 32.9 kg/hour and by using a T-die with an opening width of 0.5 mm, the white color resin is molded into a white resin plate (white resin film) with a thickness of 20 μm. Other than setting the extrusion rate to 24.6 kg/hour, the same conditions in molding the white color resin are applied in a case of molding the black color resin into a black resin plate (black resin film) with a thickness of 20 μm.

Next, the white resin film and the black resin film are overlapped, sandwiched by Kapton (registered trademark) films with thicknesses of 125 μm, placed on a silicon rubber cushion with a thickness of 1 mm, and fused together by being applied with a heating temperature of 105° C. and pressure of 25 kg/cm²; thereby forming a layered film. The layered film is cut into resin pieces of 70×70 μm sizes by using a rotary blade (manufactured by NT Inc.). Then, a release agent of Silicon Oil FS 1265-300 cst (Toray Dow Corning Silicone Co. Ltd.) is used to recover the resin pieces.

Then, the resin pieces are disposed into a container containing Silicone Oil FS1265-300 cst that is heated to 190° C. The resin pieces are heated for two minutes while being softly shaken, to thereby form the resin pieces into spherical shaped rotation particles. Then, the rotation particles are mixed with a 25° C. Silicone Oil FS1265-300 cst having the same amount as the heated 190° C. Silicone Oil FS1265-300 cst, to thereby cool the rotation particles.

Then, the rotation particles are classified by using meshes with mesh sizes of 98 μm, 83 μm, and 77 μm. Then, the rotation particles are again classified with the mesh with the mesh size of 77 μm. Then, the rotation particles are recovered with a mesh with a mesh size of 63 μm. The obtained rotation particles have an average particle diameter of 71.2 μm and a coefficient of variation of 13.8%.

Then, the rotation particles are mixed with a two component curing type silicone rubber KE 106 (Toray Dow Corning Silicone Co. Ltd.) at a density of 52% volume. After the rotation particles are sufficiently agitated and dispersed, the mixture is uniformly applied as a coating with a thickness of 200 μm onto a Teflon coating film by using a blade method. Then, the rotation particles are cured for 8 hours in an atmosphere with a heating temperature of 50° C. Thereby, a transparent substrate having rotation particles dispersed therein is obtained.

Next, the transparent substrate and the Silicone Oil SH 200-0.65 cst (Toray Dow Corning Silicone Co. Ltd.) are hermetically sealed in a vinyl bag. Here, the volume ratio between the transparent substrate and the silicone oil is 1:2. Then, the vinyl bag is loaded into an ultrasonic cleaner filled with water (Honda Electronics Co. Ltd., Type: W-113 MK-II, Output: 110 W) and is subjected to ultrasonic waves with a frequency of 24 kHz for 2 minutes. Then, the transparent substrate is extracted and is dried in room temperature for 20 minutes.

Then, the silicone rubber is dipped in Silicone Oil SH 200-20 cst (Toray Dow Corning Silicone Co. Ltd.) for 12 hours.

Then, a PET film having ITO electrodes (upper sheet) and a polyimide film attached with copper foil are adhered to the transparent substrate. Thereby, fabrication of the first example of the rotation particle display apparatus is completed.

### SECOND EXAMPLE

According to a second example of the present invention, a white color resin is fabricated by kneading 59.6 parts by weight of Petrothene 353 (manufactured by Tosoh Corporation), 40 parts by weight of a hydrophobic titanium dioxide (rutile type, particle diameter: 280 nm), and 0.4 parts by weight of a fluorescent brightening agent of Nikka Flow EFS (manufactured by Nippon Chemical Works Co. Ltd.) by using a roller mill at a heating temperature of 105° C.

A black color resin is fabricated by kneading 62 parts by weight of Petrothene 353 (manufactured by Tosoh Corporation), 2 parts by weight of carbon black, and 36 parts by weight of magnetite by using a roller mill at a heating temperature 105° C. Here, the ratio of the melt viscosity of the color resins (melt viscosity of the white color resin/melt viscosity of the black color resin) at a temperature of 190° C. is 1.90.

Next, the white color resin and the black color resin are molded into resin plates (resin films) by using a cast film molding apparatus with the same conditions of the first example, and rotation particles are fabricated in the same manner as the first example.

Then, the rotation particles are classified by using meshes with mesh sizes of 98 μm, 83 μm, and 77 μm. Then, the rotation particles are again classified twice with the mesh with the mesh size of 77 μm. Then, the rotation particles are recovered with a mesh with a mesh size of 63 μm. The obtained rotation particles have an average particle diameter of 72.5 μm and a coefficient of variation of 11.5%.

Then, the rotation particles are mixed with a two component curing type silicone rubber KE 106 (Toray Dow Corning Silicone Co. Ltd.) in a density of 52% volume. After the rotation particles are sufficiently agitated and dispersed, the mixture is uniformly applied as a coating with a thickness of 200 μm onto a Teflon coating film by using a blade method. Then, the rotation particles are cured for 8 hours in an atmosphere with a heating temperature of 50° C. Thereby, a transparent substrate having rotation particles dispersed therein is obtained.

Hereafter, the rotation particle display apparatus according to the second example is obtained by executing the same processes described in the first example.

### THIRD EXAMPLE

Other than executing a classification process by using meshes with mesh sizes of 98 μm and 83 μm and then recovering the rotation particles with a mesh with a mesh size of 63 μm, rotation particles are fabricated with the same conditions as the first example. The rotation particles obtained in the third example have an average particle diameter of 78.4 μm and a coefficient of variation of 19.1%.

### FIRST COMPARATIVE EXAMPLE

In a first comparative example, white and black color resins are fabricated with the same conditions as the first example of the present invention.

Here, the ratio of the melt viscosity of the color resins (melt viscosity of the white color resin/melt viscosity of the black color resin) at a temperature of 190° C. is 1.28.

Next, the same cast film molding apparatus used in the first example of the present invention is used. Here, by setting the heating temperature to 170° C. and the extrusion rate to 32.9 kg/hour and by using a T-die with an opening width of 0.5 mm, the white color resin is molded into a white resin plate (white resin film) with a thickness of 35 μm. Other than setting the extrusion rate to 24.6 kg/hour, the same conditions in molding the white color resin are applied in a case of molding the black color resin into a black resin plate (black resin film) with a thickness of 35 μm.

Next, a layered film is formed with the same conditions as the first example of the present invention. The layered film is cut into resin pieces of 70×70 μm sizes by using a fixed rotation round teeth blade. The resin pieces are recovered with a cutter.

Then, with the same conditions as the first example of the present invention, the resin pieces are heated with silicone oil and are formed into rotation particles.

Then, the rotation particles are classified by using a mesh with a mesh size of 98 μm and are recovered with a mesh with a mesh size of 63 μm. The obtained rotation particles have an average particle diameter of 81.6 μm and a coefficient of variation of 20.7%.

Hereafter, the rotation particle display apparatus according to the first comparative example is obtained by executing the same processes described in the first example of the present invention.

### SECOND COMPARATIVE EXAMPLE

According to a second comparative example, 16 parts by weight of Petrothene 353 (manufactured by Tosoh Corporation) and 20 parts by weight of a hydrophobic titanium dioxide (atanase type) are kneaded by using a roller mill in a heating temperature of 105° C. Then, the kneaded material is diluted with 64 parts by weight of ethylene wax in a melting state with a melting point of 125° C. by using the roller mill. Thereby, a white polyethylene/ethylene wax mixture is fabricated.

Meanwhile, 16.4 parts by weight of Petrothene 353 (manufactured by Tosoh Corporation), 2 parts by weight of carbon black, and 16 parts by weight of magnetite are kneaded by using a roller mill at a heating temperature of 105° C. Then, the kneaded material is kneaded with 65.6 parts by weight of ethylene wax in a melting state with a melting point of 125° C. by using the roller mill. Thereby, a black polyethylene/ethylene wax mixture is fabricated. Here, the ratio of the melt viscosity of the color resins (melt viscosity of the white color resin/melt viscosity of the black color resin) at a temperature of 190° C. is 2.95.

Then, each of the polyethylene/ethylene wax mixtures are respectively formed into a film with a thickness of 15 μm by applying a press machine with a temperature of 130° C. A layered film is fabricated by fusing the films at a temperature of 110° C. Then, the layered film is dipped in liquid nitrogen. Then, the layered film is ground by an ultrasonic homogenizer. Thereby, resin pieces having a average size of 50 μm×50 μm and a size distribution ranging from 10 μm to 120 μm.

The resin pieces are disposed into Silicon Oil SH 200-100 cst (Toray Dow Corning Silicone Co. Ltd.) with a temperature of 150° C. for 3 minutes. Then, the rotation particles are cooled by being mixed with a 25° C. Silicone Oil FS1265-300 cst having the same amount as the heated 150° C. Silicone Oil SH 200-100 cst. Thereby, the fabrication of the rotation particles is completed.

### THIRD COMPARATIVE EXAMPLE

According to a third comparative example, other than using Silicone Oil SH 200-100 cst (specific gravity: 0.96) and not shaking the silicone oil in the process of heating the resin pieces (specific gravity: 1.3), rotation particles are fabricated in the same manner as the second example. In the third comparative example, the rotation particles cannot to be recovered since aggregation and adhesion upon the container occurs along with sedimentation of the rotation particles.

[Method of Evaluating Rotation Particle Diameter R and Borderline Length L]

The diameter of the rotation particle R and the length of the borderline of the rotation particle L for the first-third examples of the present invention and the first-second comparative examples were measured and evaluated.

The diameter of the rotation particle R and the length of the borderline of the rotation particle L were obtained by applying an alternating voltage of approximately 1 Hz to a rotation particle display apparatus, videotaping the transmitted image or reflected image of the rotating rotation particles, capturing the image in a computer, and applying image processing software to the image. The evaluation method is described in detail below.

First, an alternating voltage of 1 Hz is applied to each rotation particle display apparatus for the first-third examples of the present invention and the first-second comparative examples. Then, transmitted or reflected images of rotating rotation particles are enlarged with an optical microscope (STM-UM-BDZ-100(S) manufactured by Olympus Corp.). The images are captured by a CCD camera (manufactured by Ikegami Tsushinki Co. Ltd.) and recorded by a video recorder. The images are read into a computer with an MPEG recorder (USB-MPG manufactured by I-O Data Device Inc.).

Then, among the sequential images of the rotating rotation particles, MPEG image reproduction software in the computer is used to capture still images which show a rotation particle having a borderline traversing substantially at the center of the rotation particle and delineating the rotation particle so that its two colors have substantially the same area. This process is repeated to obtain 50 to 100 still images of the rotation particles.

Then, the still images are enlarged with a total magnitude of approximately 5000 times so that, for example, a rotation particle having a particle diameter of 70 μm is enlarged to 350 mm. Then, the images are subjected to an edge enhancement process (setting: default) by image processing software (Product Name: Photoshop, manufactured by Adobe Systems Inc.). Then, the diameter of the rotation particle R and the length of the borderline between the two colors L are obtained.

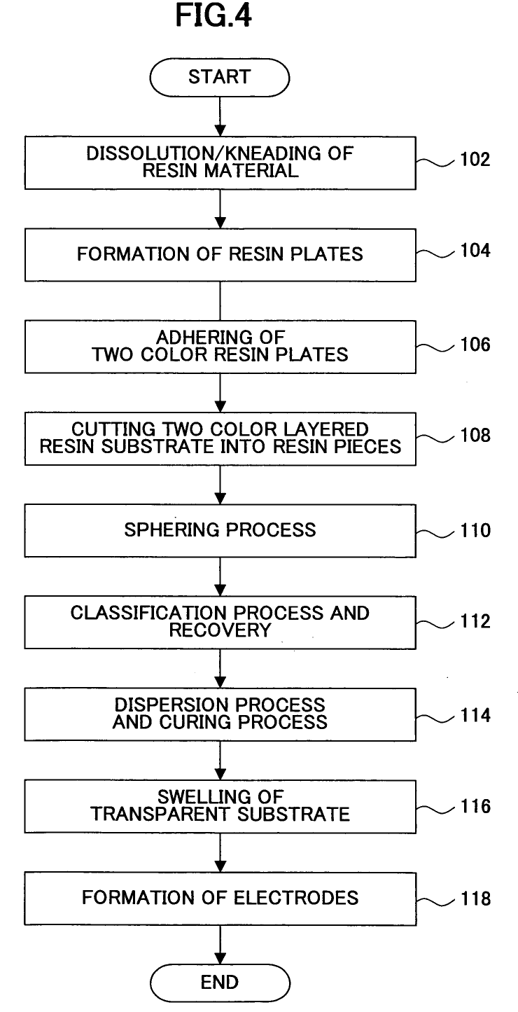

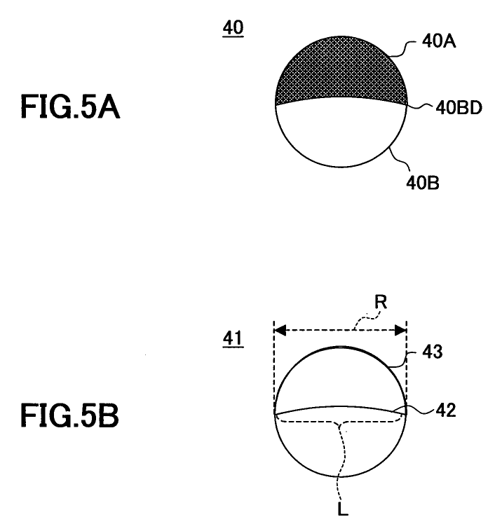

FIG. 5A is a drawing showing an example of the still image of the rotation particle. FIG. 5B is a drawing showing an example of the still image subjected to the edge enhancement process. As shown in FIGS. 5A and 5B, the borderline between white and black of the rotation particle and the contour of the rotation particle can be obtained from the edge enhancement process. Accordingly, length L is obtained from the length of the borderline L, and diameter R is obtained from the contour of the rotation particle. Technically, the contour of the rotation particle is an ellipse that is close to a circle. Here, in a case where the degree of circularity is 0.8 or more, the diameter R is obtained assuming that the rotation particle is a circle. In a case where the degree of circularity is less than 0.8, the rotation particle is assumed to be an ellipse, in which the short diameter a and the long diameter b of the ellipse are obtained for obtaining a diameter R of (a+b)/2.

Then, a statistical process regarding the value of the ratio between the length of the borderline and the diameter of the rotation particle L/R is conducted. Accordingly, the distribution of the L/R values is obtained by categorizing the L/R values into “1.0 or more and no greater than 1.2”, “greater than 1.2 and less than 1.4”, and “1.4 or more”.

It is to be noted that in a case of obtaining solely rotation particles rather than a display apparatus, transmitted or reflected images of rotation particles in a still state can be captured with a digital camera (DP-10 manufactured by Olympus Corp.).

[Method of Evaluating Contrast of Rotation Particle Display Apparatus]

The contrast of each rotation particle display apparatus of the first-third examples of the present invention and the first-second comparative examples was evaluated.

In evaluating the contrast, a calorimeter (SpectroEye manufactured by Gretag Macbeth, Light Source: D 65, Visual Field: 2 degrees) was used, in which reflection densities of white display and black display are measured by applying a voltage of 200 V in both positive and negative directions to the ITO electrode and the copper foil electrode at opposite sides of the rotation particle display apparatus. The obtained measurements are converted to reflectivity, to thereby obtain the reflectivity ratio (i.e. reflectivity of white display/reflectivity of black display).

[Evaluation of L/R Value and Contrast]

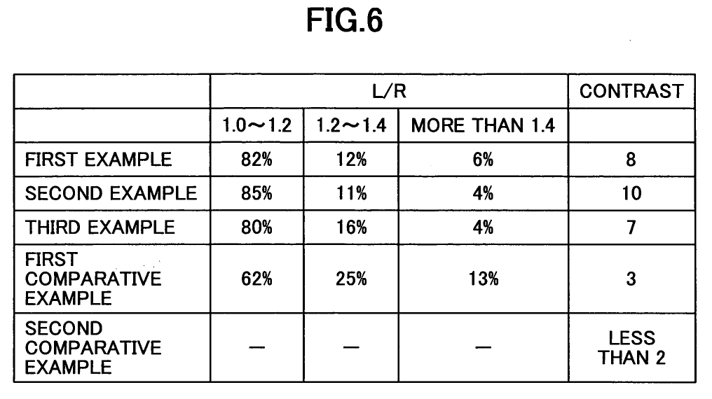

FIG. 6 is a table showing evaluation results of L/R values and contrast of the rotation particle display apparatuses of the first-second examples of the present invention and the first-second comparative examples. It is to be noted that the symbol “-” in the table indicates that measurement could not be conducted.

The table in FIG. 6 shows that a proportion of 80% or more of the rotation particles of the first-third examples of the present invention have an L/R value in the range of “1.0 or more and no greater than 1.2”. Furthermore, the contrasts of the rotation particle display apparatuses including the rotation particles of the first-third examples of the present invention are 7 or more. It is to be noted that visibility is satisfactory and acceptable when the contrast is 5 or more. Particularly, since the mesh with the mesh size of 77 μm is used for a greater number of times in the second example of the present invention, the proportion of rotation particles having an L/R value in the range of “1.0 or more and no greater than 1.2” is 85%. Accordingly, this resulted to a satisfactory contrast of 10.

On the other hand, the proportion of rotation particles of the first comparative example having an L/R value in the range of “1.0 or more and no greater than 1.2” is 62%. The contrast of the display apparatus of the first comparative example has a low contrast value of 3.

Furthermore, in the rotation particle of the second comparative example, the melt viscosity ratio of the color resins at a temperature of 190° C. is a large value of 2.95. Furthermore, the white resin material covers the black resin material in the sphering process. Furthermore, the borderline between the two colors is diverse. Therefore, the rotation particle of the second comparative example has its white region covering approximately 80% of the entire surface and demonstrated an unstable rotation movement. Accordingly, the L/R value of the rotation particle of the second comparative example could not be measured.

As a result, the rotation particle display apparatus is able to provide a greater contrast as the proportion of the rotation particles having an L/R value in the range of “1.0 or more and no greater than 1.2” becomes larger.

It is to be noted that, although the above described embodiments and examples of the present invention are described employing rotation particles with two contrasting colors of white and black, other colors may be alternatively be employed as long as the two regions of the rotation particle are of different colors.

Further, the present invention is not limited to these embodiments, but variations and modifications may be made without departing from the scope of the present invention.

1. A rotation particle display apparatus comprising:
a plurality of rotation particles for rotating in accordance with an applied electric field for displaying an image, each rotation particle having a first region and a second region, the first and second regions having different colors and different charge characteristics;
wherein when the rotation particles are viewed two-dimensionally from a direction where a borderline between the first and second regions is situated substantially at a center of the rotation particle and where the first region has an area which is substantially the same as that of the second region,
the proportion of the rotation particles that satisfy a relation of 1.0≦L/R≦1.2 is 80% or more,
wherein “L” represents a length of the borderline between the first and second regions, and “R” represents a diameter of a circle corresponding to a contour of the rotation particle.

2. The rotation particle display apparatus as claimed in claim 1, further comprising:
first and second electrodes for applying the electric field to the rotation particles;
a transparent substrate is kept between the first and second electrodes;
a plurality of cavities are formed inside the transparent substrate; and
the each cavity is filled with a rotation particle and a dielectric liquid.

3. The rotation particle display apparatus as claimed in claim 1, wherein the rotation particles have an average particle diameter ranging from 10 μm to 100 μm, and have a coefficient variation which is 20% or less.

4. The rotation particle display apparatus as claimed in claim 1, wherein the first and second regions each include a resin material containing a thermoplastic resin and a coloring agent, wherein a melt viscosity MV₁ of the resin material of the first region at a temperature of 190° C. and a melt viscosity MV₂ of the resin material of the second region at a temperature of 190° C. have a ratio MV₁/MV₂ ranging from 0.5 to 2.0.

5. The rotation particle display apparatus as claimed in claim 1, wherein one of the first and second regions is a white colored region containing a rutile type titanium dioxide and a fluorescent brightening agent.

6. The rotation particle display apparatus as claimed in claim 2, wherein the transparent substrate includes silicone rubber, wherein the dielectric liquid includes silicone oil.

7. A method of manufacturing a rotation particle display apparatus comprising the steps of:
a) forming two resin plates of two different colors from two resin materials;
b) forming a two color layered resin substrate by adhering the two resin plates;
c) cutting the two color layered resin substrate into resin pieces;
d) forming the resin pieces into spherical rotation particles by heating the resin pieces inside a liquid; and
e) classifying the rotation particles according to the particle diameters of the rotation particles.

8. The method as claimed in claim 7, wherein the resin pieces are shaken while being heated inside the liquid in step d).

9. The method as claimed in claim 7, wherein the liquid has a kinematic viscosity ranging from 3×10⁻⁴ m²/s to 1×10⁻² m²/s at a temperature of 25° C.

10. The method as claimed in claim 7, wherein a difference between a specific gravity of the liquid and a specific gravity of the resin pieces is no more than 0.3 at a temperature of 25° C.

11. The method as claimed in claim 7, wherein a melt viscosity ratio between the two resin materials at a temperature of 190° C. ranges from 0.5 to 2.0.

12. The method as claimed in claim 7, wherein the liquid includes silicone oil.

13. The method as claimed in claim 12, wherein the rotation particles are cooled after the heating of the resin pieces, wherein the rotation particles are cooled to a temperature lower than a softening point of the resin materials by being mixed with a same kind of silicone oil used for heating the resin pieces.

14. The method as claimed in claim 7, wherein the two color layered resin substrate is cut into predetermined sizes with a rotary blade.

15. The method as claimed in claim 7, wherein after the cutting of the two color layered resin substrate, the resin pieces are recovered by using a releasing agent.
